(19) United States
(12) Patent Application Publication
(10) Pub. No.: US 2010/0164899 A1
(43) Pub. Date: Jul. 1, 2010

(54) MATRIX RESISTIVE TOUCH DEVICE

(76) Inventors: Cheng-Ko Wu, Taoyuan County (TW); Ming-Tsung Wu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/344,269

(22) Filed: Dec. 25, 2008

(51) Int. Cl. G06F 3/045

(52) U.S. Cl. 345/174

(57) ABSTRACT

A matrix resistive touch device includes a first substrate, a spacer layer, and a second substrate. The first substrate is used for detecting a position of an input point in a first direction. The second substrate is used for detecting the position of the input point in a second direction. The first substrate has a conductive layer. The conductive layer has a voltage difference in the first direction. The second substrate has a plurality of electrodes. The plurality of electrodes is perpendicular to the second direction. The spacer layer is located between the first substrate and the second substrate for separating the conductive layer and the plurality of electrodes.

### BACKGROUND OF THE INVENTION

1. Field of the Invention

The present invention relates to a touch device, and more particularly, to a matrix resistive touch device.

2. Description of the Prior Art

Touch devices includes projected capacitive touch devices and passive matrix resistive touch devices. The projected capacitive touch devices cannot operate after dressing the gloves. The passive matrix resistive touch devices includes upper and lower two substrates. In general, the upper substrate is an indium tin oxide (ITO) film, and the lower substrate is an ITO glass. Two substrates are patterned with the strips of electrodes and separated by a dot spacer. The electrodes of the upper and lower substrates form a matrix. When an external force from an input point is applied to the upper substrate, the electrodes of the upper and lower substrates are contacted forming a short circuit so as to generate a digital signal. Thus, the position of the input point can be calculated according to the digital signal.

Please refer to FIG. 1. FIG. 1 is a schematic diagram of a conventional touch panel 10. The touch panel 10 includes a first substrate 12, a spacer layer 14, and a second substrate 16. The first substrate 12 detects a position of an input point in the X direction, and the second substrate 16 detects the position of the input point in the Y direction. The plurality of first electrodes 13 is formed on the first substrate 12, and the plurality of second electrodes 17 is formed on the second substrate 16. The spacer layer 14 is located between the first substrate 12 and the second substrate 16, for separating the plurality of first electrodes 13 and the plurality of second electrodes 17. When the first substrate 12 contacts the second substrate 16, the coordinate values of the input point in the X direction and in the Y direction can be obtained according to a short voltage of the first electrodes 13 and the second electrodes 17.

Please refer to FIG. 2. FIG. 2 is a schematic diagram of a conventional touch device 20. The touch device 20 includes not only the touch panel 10, but also a complex programmable logic device (CPLD) 22 and a micro controller unit (MCU) 24. The CPLD 22 can process X digital signals and Y digital signals generated by the plurality of first electrodes 13 and the plurality of second electrodes 17. The touch panel 10 scans repeatedly the plurality of first electrodes 13 on the first substrate 12 or the plurality of second electrode 17 on the second substrate 16 when detecting an input point. The CPLD 22 can obtain the position of the intersection of the plurality of first electrodes 13 and the plurality of second electrodes according to the X digital signals and the Y digital signals. Finally, the MCU 24 generates the coordinate values (X,Y) of the input point.

The first substrate and the second substrate of the conventional touch panel are required to be patterned with the strips of electrodes. However, the yield of the substrate patterned with the strips of electrodes cannot be improved as the touch panel becomes bigger and bigger. In addition, the touch panel has to pass the hitting test. The substrate patterned with the strips of electrodes has more chances to generate the ITO conductive layer peeling than the substrate without the patterned electrodes after the hitting test. Two substrates cannot conduct well because of the peeling, so that the position of the input point cannot be determined correctly.

### SUMMARY OF THE INVENTION

According to an embodiment of the present invention, a matrix resistive touch device comprises a first substrate, a first conductive layer, a second substrate, a plurality of electrodes, and a spacer layer. The first substrate is used for detecting a position of an input point in a first direction. The first conductive layer, formed on the first substrate, has a voltage difference in the first direction. The second substrate is used for detecting the position of the input point in a second direction. The plurality of electrodes is formed on the second substrate and perpendicular to the second direction. The spacer layer is formed between the first substrate and the second substrate, for separating the conductive layer and the plurality of electrodes.

According to another embodiment of the present invention, a matrix resistive touch device comprises a first substrate, a plurality of first electrodes, a second substrate, a plurality of second electrodes, and a spacer layer. The first substrate is used for detecting a position of an input point in a first direction. The plurality of first electrodes, formed on the second substrate, has a first voltage difference in the first direction. The second substrate is used for detecting the position of the input point in a second direction. The plurality of second electrodes, formed on the second substrate, has a second voltage difference in the second direction. The spacer layer is formed between the first substrate and the second substrate, for separating the plurality of first electrodes and the plurality of second electrodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional touch panel.

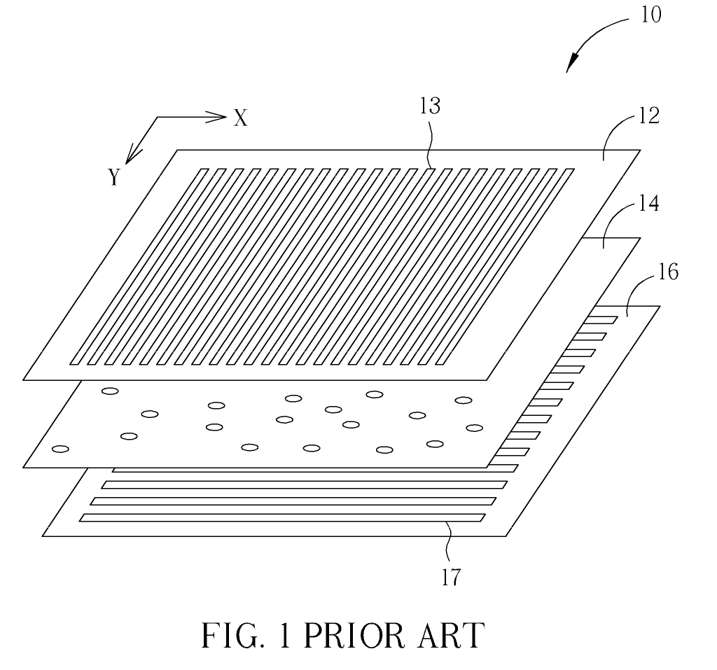

FIG. 2 is a schematic diagram of a conventional touch device.

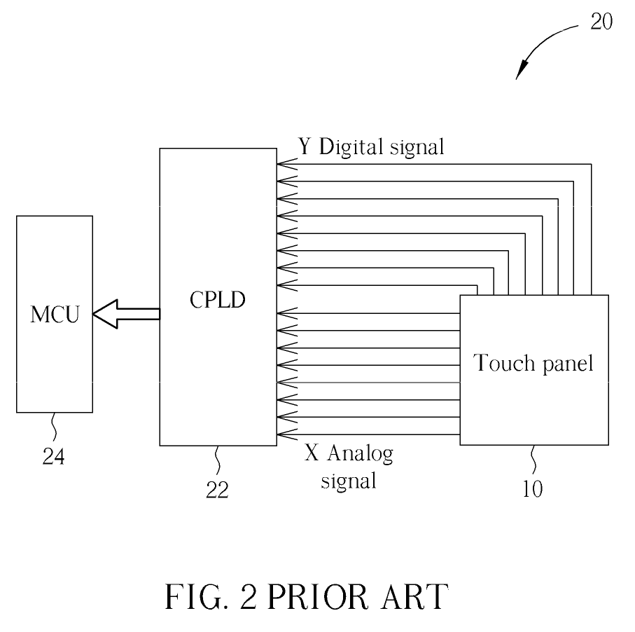

FIG. 3 is a schematic diagram of a touch panel according to the first embodiment of the present invention.

FIG. 4 is a schematic diagram of a touch device according to the first embodiment of the present invention.

FIG. 5 is a schematic diagram of a touch panel according to the second embodiment of the present invention.

FIG. 6 is a schematic diagram of a touch device according to the second embodiment of the present invention.

### DETAILED DESCRIPTION

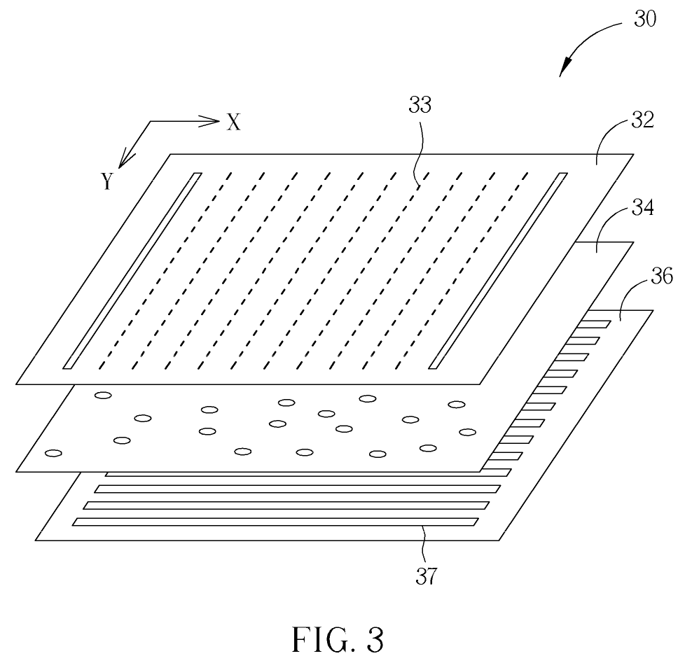

Please refer to FIG. 3. FIG. 3 is a schematic diagram of a touch panel 30 according to the first embodiment of the present invention. touch panel 30 comprises a first substrate 32, a spacer layer 34, and a second substrate 36. The first substrate 32 detects a position of an input point in the X direction, and the second substrate 36 detects the position of the input point in the Y direction. In this embodiment, the first substrate 32 is an indium tin oxide (ITO) film, the spacer layer 34 is a dot spacer, and the second substrate 36 is an ITO glass. The first substrate 32 has a conductive layer without patterned electrodes, and the second substrate 36 has a plurality of electrodes 37. The spacer layer 34 is located between the first substrate 32 and the second substrate 36, for separating the conductive layer on the first substrate 32 and the plurality of electrodes 37 on the second substrate 36. The plurality of electrodes 37 on the second substrate 36 is formed by the photo development process, the indium tin oxide etching, or the etching resist ink. In addition, the conductive layer can use material such as indium tin oxide (ITO), indium zinc oxide (IZO), aluminum zinc oxide (AZO), or organic films. Since the first substrate 32 is not required to be patterned with the electrodes, the reliability of the first substrate 32 is better than the substrate with the patterned electrodes. The first substrate 32 has a voltage difference in the X direction, so electric potential lines 33 are generated in the X direction. When two substrates are contacted, the voltage differences of the electric potential lines 33 are used to calculate the X coordinate value of the input point. The plurality of electrodes 37 on the second substrate 36 has a common voltage. When two substrates are contacted, the Y coordinate value of the input point is calculated according to the voltage differences of the plurality of electrodes 37. In the first embodiment of the present invention, the touch panel 30 patterns only the second substrate 36 with the plurality of electrodes 37. The first substrate 32 is applied to electric voltages to generate electric potential lines 33 instead of patterned electrodes. Thus, the process of the touch panel 30 becomes simpler. If the input panel is the first substrate 32, the touch panel 30 can have higher reliability of the hitting test.

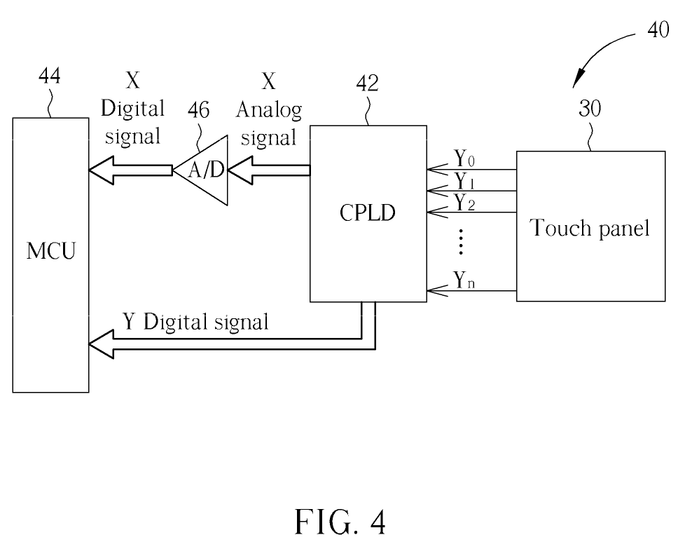

Please refer to FIG. 4. FIG. 4 is a schematic diagram of a touch device 40 according to the first embodiment of the present invention. The touch device 40 comprises not only the touch panel 30, but also a complex programmable logic device (CPLD) 42, an analog to digital (A/D) converter 46, and a micro controller unit (MCU) 44. The CPLD 42 can process short voltages of the plurality of electrodes 37 on the second substrate 36 and the conductive layer on the first substrate 32 so as to generate X analog signals. In addition, the CPLD 42 has a function of a multiplexer for transmitting Y digital signals to the MCU 44. The A/D converter 46 converts the X analog signals to X digital signals. The touch panel 30 scans repeatedly the plurality of electrodes 37 on the second substrate 36 when detecting an input point. The Y digital signals can be obtained from the plurality of electrodes 37, and the X analog signals can be obtained by the CPLD 42 according to the voltage difference of the electric potential lines 33. The A/D converter 46 converts the X analog signals to the X digital signals. Finally, the MCU 44 generates the coordinate values (X,Y) of the input point according to the X digital signals and Y digital signals.

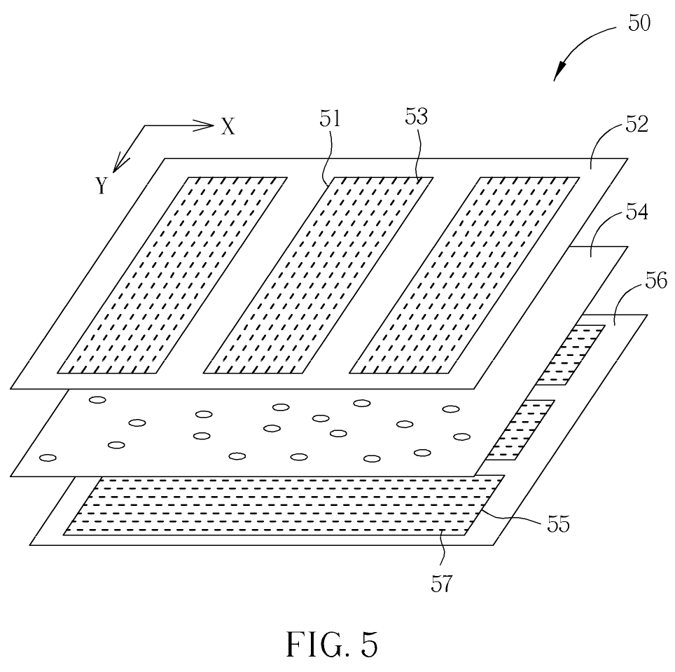

Please refer to FIG. 5. FIG. 5 is a schematic diagram of a touch panel 50 according to the second embodiment of the present invention. The touch panel 50 comprises a first substrate 52, a spacer layer 54, and a second substrate 56. The first substrate 52 detects a position of an input point in the X direction, and the second substrate 56 detects the position of the input point in the Y direction. The plurality of first electrodes 51, formed on the first substrate 52, has a first voltage difference in the X direction, so electric potential lines 53 are generated in the X direction. The plurality of second electrodes 55, formed on the second substrate 56, has a second voltage difference in the Y direction, so electric potential lines 57 are generated in the Y direction. The spacer layer 54 is located between the first substrate 52 and the second substrate 56, for separating the plurality of first electrodes 51 and the plurality of second electrodes 51. In this embodiment, the first substrate 52 and the second substrate 56 comprise the first electrodes 51 and the second electrodes 55 respectively. The first electrodes 51 and the second electrodes 55 need to have sufficient widths so as to generate the electric potential lines 53 and the electric potential lines 55. When two substrates are contacted, the X and Y coordinate values of the input point are calculated according to the voltage differences of the first electrodes 51 and the second electrodes 55. In the second embodiment of the present invention, the touch panel 50 has first electrodes 51 and the second electrodes 55 on the first substrate 52 and the second substrate 56 respectively, but the first electrodes 51 and the second electrodes 55 have a large width and a small amount. Thus, the process of the touch panel 50 becomes simpler.

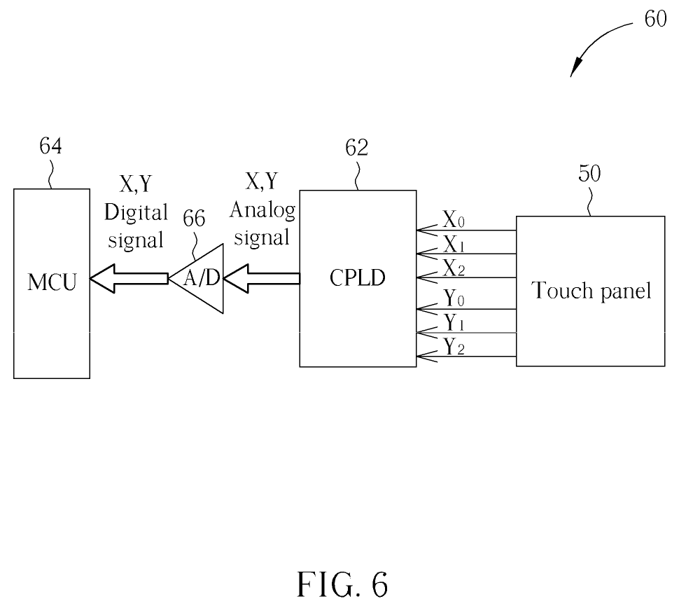

Please refer to FIG. 6. FIG. 6 is a schematic diagram of a touch device 60 according to the second embodiment of the present invention. The touch device 60 comprises not only the touch panel 50, but also a complex programmable logic device (CPLD) 62, an analog to digital (A/D) converter 66, and a micro controller unit (MCU) 64. The CPLD 62 can process short voltages of the plurality of first electrodes 51 and the plurality of second electrodes 51 so as to generate X analog signals and Y analog signals. The A/D converter 46 converts the X analog signals and the Y analog signals to X digital signals and Y digital signals respectively. The touch panel 50 scans repeatedly the plurality of first electrodes 51 on the first substrate 52 or the plurality of second electrodes 55 on the first substrate 56 when detecting an input point. The CPLD 62 obtains the X analog signals and the Y analog signals according to the voltage difference of the electric potential lines 53 of the first electrodes 51 and the electric potential lines 57 of the second electrodes 55. The A/D converter 66 converts the X analog signals and the Y analog signals to the X digital signals and the Y digital signals respectively. Finally, the MCU 64 generates the coordinate values (X,Y) of the input point according to the X digital signals and Y digital signals.

In conclusion, the matrix resistive touch device according to the present invention comprises a touch panel, a complex programmable logic device, an analog to digital converter, and a micro controller unit. The touch panel comprises a first substrate, a spacer layer, and a second substrate. The first substrate is used for detecting a position of an input point in a first direction. The second substrate is used for detecting the position of the input point in a second direction. In the first embodiment, the first substrate has a conductive layer, and the conductive layer has a voltage difference in the first direction. The second substrate has a plurality of electrodes, and the plurality of electrodes is perpendicular to the second direction. In the second embodiment, the first substrate has a plurality of first electrodes, and the plurality of first electrodes has a first voltage difference in the first direction. The second substrate has a plurality of second electrodes, and the plurality of second electrodes has a second voltage difference in the second direction. Thus, the matrix resistive touch device of the present invention can simplify the process of the patterned electrodes to improve the durability of the touch device.

Those skilled in the art will readily observe that numerous modifications and alterations of the device and method may be made while retaining the teachings of the invention.

What is claimed is:

1. A matrix resistive touch device, comprising:
a first substrate, for detecting a position of an input point in a first direction;
a first conductive layer, formed on the first substrate, having a voltage difference in the first direction;
a second substrate, for detecting the position of the input point in a second direction;
a plurality of electrodes, formed on the second substrate, perpendicular to the second direction; and
a spacer layer, formed between the first substrate and the second substrate, for separating the conductive layer and the plurality of electrodes.

2. The touch device of claim 1, further comprising:
a complex programmable logic device (CPLD), for processing a short voltage of the plurality of electrodes and the conductive layer so as to generating analog signals of the first direction and digital signals of the second direction;
an analog to digital (A/D) converter, for converting the analog signals of the first direction to digital signals of the first direction; and
a micro controller unit (MCU), for generating coordinate values of the input point according to the digital signals of the first direction and the digital signals of the second direction.

3. The touch device of claim 1, wherein the conductive layer is an indium tin oxide (ITO) transparent conductive layer.

4. The touch device of claim 1, wherein the plurality of electrodes is formed by etching an indium tin oxide (ITO) transparent conductive layer.

5. The touch device of claim 1, wherein the plurality of electrodes has a common voltage.

6. The touch device of claim 1, wherein the spacer layer is a dot spacer.

7. A matrix resistive touch device, comprising:
a first substrate, for detecting a position of an input point in a first direction;
a plurality of first electrodes, formed on the second substrate, having a first voltage difference in the first direction;
a second substrate, for detecting the position of the input point in a second direction;
a plurality of second electrodes, formed on the second substrate, having a second voltage difference in the second direction; and
a spacer layer, formed between the first substrate and the second substrate, for separating the plurality of first electrodes and the plurality of second electrodes.

8. The touch device of claim 7, further comprising:
a complex programmable logic device (CPLD), for processing a short voltage of the plurality of first electrodes and the plurality of second electrodes so as to generating analog signals of the first direction and analog signals of the second direction;
an analog to digital (A/D) converter, for converting the analog signals of the first direction and the analog signals of the second direction to digital signals of the first direction and digital signals of the second direction respectively; and
a micro controller unit (MCU), for generating coordinate values of the input point according to the digital signals of the first direction and the digital signals of the second direction.

9. The touch device of claim 7, wherein the plurality of first electrodes and the plurality of second electrodes are formed by etching (ITO) transparent conductive layers.

10. The touch device of claim 7, wherein the plurality of first electrodes is perpendicular to the first direction and the plurality of second electrodes is perpendicular to the second direction.

11. The touch device of claim 7, wherein the spacer layer is a dot spacer.
